(19) United States
(12) Patent Application Publication
(10) Pub. No.: US 2013/0081295 A1
(43) Pub. Date: Apr. 4, 2013

(54) BOTTLE DRYER

(71) Applicants: Brian D. Mathweg, Vancouver, WA (US); Dave Mathweg, Roseburg, OR (US)

(72) Inventors: Brian D. Mathweg, Vancouver, WA (US); Dave Mathweg, Roseburg, OR (US)

(21) Appl. No.: 13/631,648

(22) Filed: Sep. 28, 2012

Related U.S. Application Data
(60) Provisional application No. 61/540,680, filed on Sep. 29, 2011.

(51) Int. Cl. F26B 25/00

(52) U.S. Cl. 34/104

(57) ABSTRACT

A bottle dryer is provided for drying beer bottles and includes a flat plane of notched bottle drying holes into which 12 oz, 22 oz, and/or Grolsch type beer bottles can be inserted top down. In some embodiments, a first angled plane of notched bottle drying holes is deposed to one side of said flat plane into which 12 oz, 22 oz, and/or Grolsch type beer bottles can be inserted top down at an angle from the flat plane. The bottle dryer can further include a second angled plane of notched bottle drying holes deposed to another side of said flat plane opposite the side to which the first angled plane of notched bottle drying holes is attached, and angled at a mirror image angle to said first angled plane of notched bottle drying holes, such that when bottle are inserted in each of the bottle drying holes in said flat plane and in said first and second angled planes, the bottles are displayed in a fan arrangement and do not contact each other.

### CROSS-REFERENCE TO RELATED APPLICATION

This application is a non-provisional of and claims priority to co-pending U.S. Provisional Patent Application Serial No. 61/540,680 filed 29 Sep. 2011, herein incorporated by reference.

### FIELD OF THE INVENTION

The present invention relates to methods and apparatus for drying bottles in the home brew industry.

BACKGROUND

Home brewing is a popular hobby. In home brewing, bottles are frequently reused. To sanitize the bottles, they must be drained and dried. Bottles come in different sizes, typically 12 oz. or 22 oz. Additionally, in addition to normal bottle tops, Grolsch beer bottle tops include swing tops. Existing home brew bottle drainers and dryers largely revolve around a traditional old school beer tree.

### SUMMARY AND ADVANTAGES

A bottle dryer is provided for drying beer bottles and includes a flat plane of notched bottle drying holes into which 12 oz, 22 oz, and/or Grolsch type beer bottles can be inserted top down. In some embodiments, a first angled plane of notched bottle drying holes is deposed to one side of said flat plane into which 12 oz, 22 oz, and/or Grolsch type beer bottles can be inserted top down at an angle from the flat plane. The bottle dryer can further include a second angled plane of notched bottle drying holes deposed to another side of said flat plane opposite the side to which the first angled plane of notched bottle drying holes is attached, and angled at a mirror image angle to said first angled plane of notched bottle drying holes, such that when bottle are inserted in each of the bottle drying holes in said flat plane and in said first and second angled planes, the bottles are displayed in a fan arrangement and do not contact each other.

The bottle dryer of the present invention presents numerous advantages, including: (1) works with the standard sizes of bottles used in the home brewing industry; (2) works with Grolsch bottle top styles; (3) allows a number of bottles, of different sizes, to be dried at one time in a condensed and attractive arrangement. Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of a bottle dryer and, together with the detailed description, serve to explain the principles and implementations of the invention.

FIG. 1 shows three types of standard beer bottles that may be dried in the bottle dryer.

FIG. 2 shows a top down plan view of an embodiment of a bottle dryer.

FIG. 3 shows a side plan view of an embodiment of a bottle dryer

FIG. 4 shows an end plan view of an embodiment of a bottle dryer

FIG. 5 shows a perspective view from the front of an embodiment of a bottle dryer.

FIG. 6 is a perspective view from the front of the first embodiment of a bottle dryer in use holding three 22 oz beer bottles.

FIG. 7 is a perspective view from the side of the first embodiment of a bottle dryer in use holding three 22 oz beer bottles.

FIG. 8 is a front perspective view of the first embodiment of a bottle dryer shown holding a 12 oz beer bottle, a 22 oz beer bottle and a Grolsch type beer bottle.

FIG. 9 is a top view of a second embodiment of a bottle dryer.

FIG. 10 is a bottom view of a second embodiment of a bottle dryer.

### REFERENCE NUMBERS USED IN DRAWINGS

Turning now descriptively to the drawings, in which similar reference characters denote similar elements throughout the several views, the figures illustrate applicants' bottle dryer. With regard to the reference numerals used, the following numbering is used throughout the various drawing figures:

10 first embodiment of a bottle dryer

12 angled bottle drying hole

14 bottle drying hole notch

16 angled plane

18 flat plane

20 straight bottle drying hole

22 second embodiment of a bottle dryer

A 12 oz. bottle

B 22 oz. bottle

C Grolsch type bottle

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

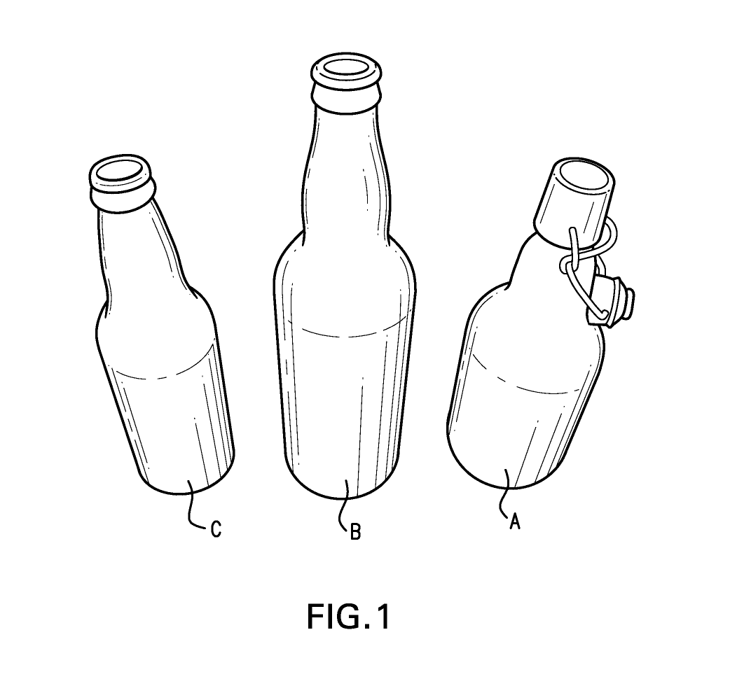

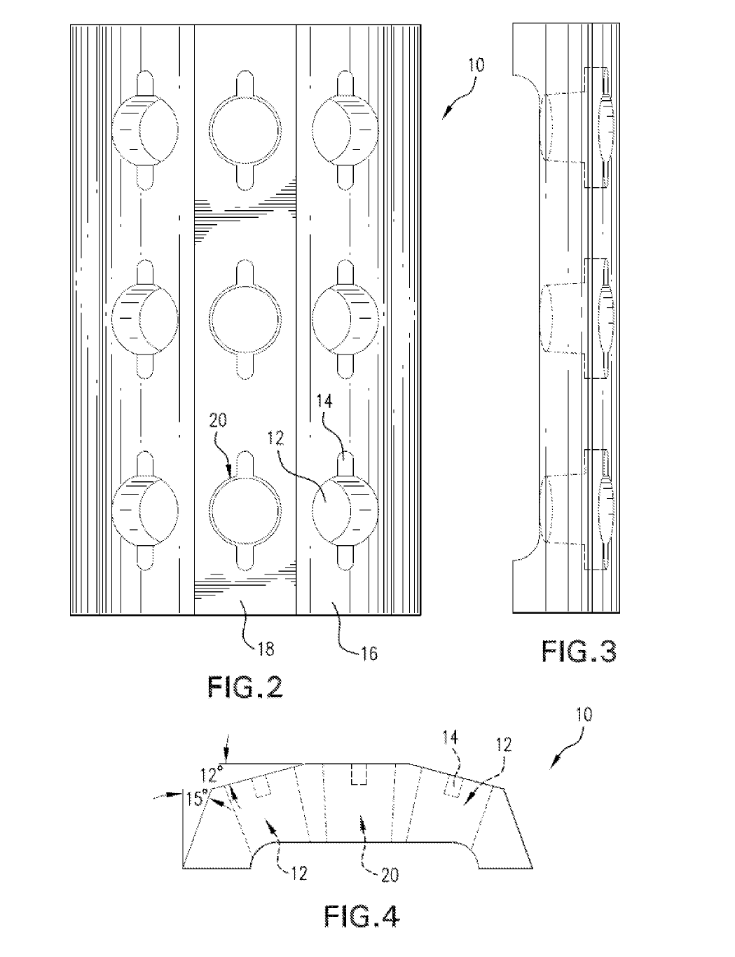

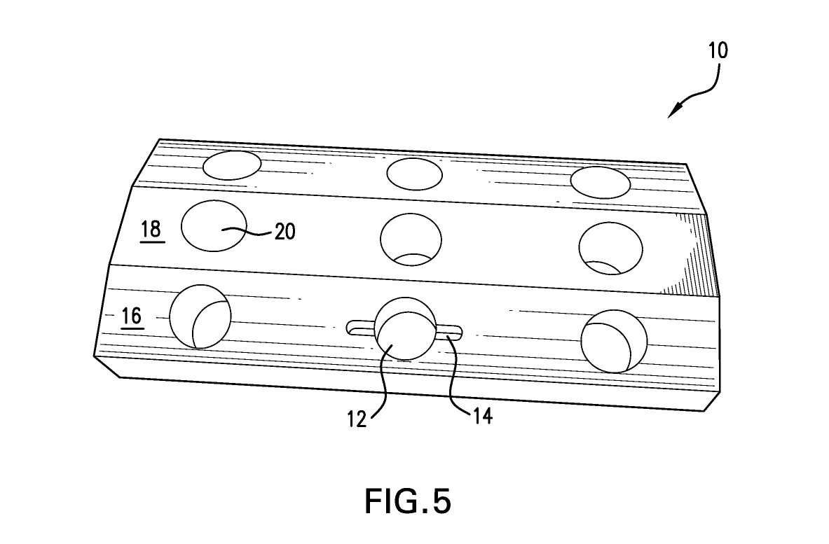

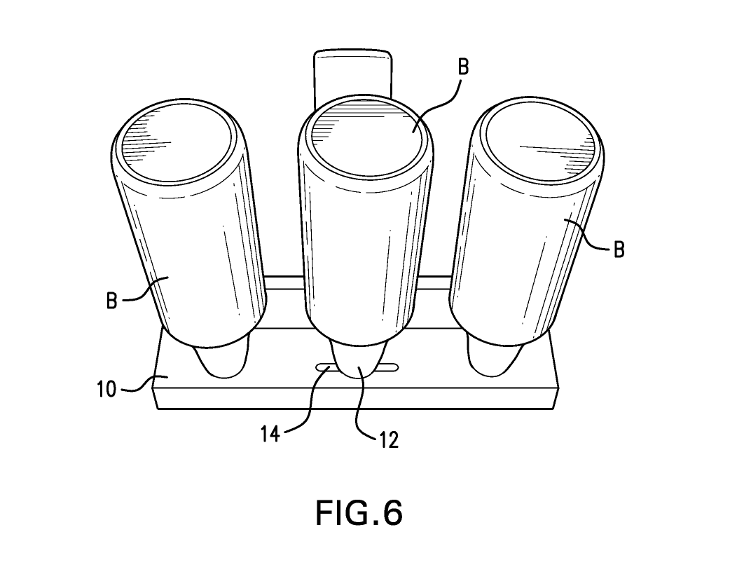

FIGS. 2-7 illustrate a first embodiment of a bottle dryer 10 configured for drying three standard bottle sizes shown in FIG. 1: Grolsch bottle top bottle, A, 22 oz bottle, B, and 12 oz. bottle, C, see FIG. 1. The bottle dryer 10 is configured for drying beer bottles and includes a flat plane 18 of straight bottle drying holes 20. Beer bottles of 12 oz, 22 oz, and/or Grolsch type can be inserted top down in the straight bottle drying holes 20. The bottle dryer 10 also includes a first angled plane 16 of angled bottle drying holes 12 to one side of said flat plane 18. Beer bottles of 12 oz, 22 oz, and/or Grolsch type can be inserted top down at an angle from the flat plane 18. The bottle dryer 10 can further include a second angled plane 16 of angled bottle drying holes 12 to another side of said flat plane 18 opposite the side to which the first angled plane 16 is attached, and angled at a mirror image angle to said first angled plane 16. The bottle dryer 10 is thus configured such that when bottles are inserted in each of the straight bottle drying holes 20 in the flat plane 18 and in the angled bottle drying hole 12 of the said first and second angled planes 16, the bottles are displayed in a fan arrangement and do not contact each other.

This embodiment of the bottle dryer 10 preferably has three planes with rows of bottle drying holes 12, 20. The flat plane, 18, preferably in the center of the bottle dryer 10, is substantially flat and provided with a plurality of straight bottle drying holes 20. Two substantially mirror image angled planes 16 on either side of the flat plane 18, each provided with a plurality of angled bottle drying holes 12. Angled planes 16 are preferably 12 degrees relative to the flat plane 18.

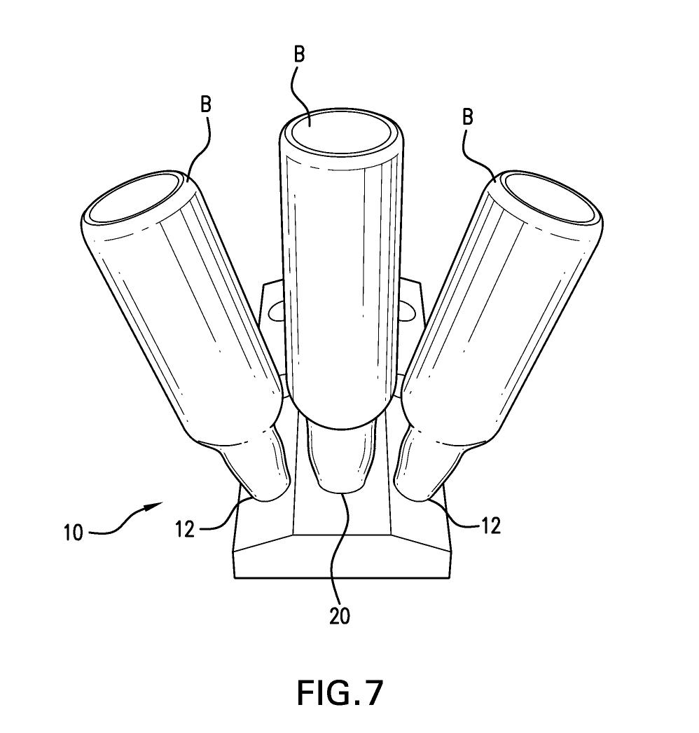

The angled bottle drying holes 12, allow bottles to be inserted for drying at an angle. Angled bottle drying holes 12 are angled at approximately 45 to 85 degrees relative to the flat plane 18. The straight bottle drying holes 20 allow bottles to be inserted straight up and down for drying. The straight bottle drying holes 20 are substantially angled at 90 degrees relative to the flat plane 18. As shown in FIG. 7, when bottles are all inserted next to each other, the angled bottle drying holes 12 on either side of the straight bottle drying hole 20 allows the bottles all to fit in a fanned out geometry without hitting each other. Bottle drying holes 12, 20 are preferably 1¼″ diameter holes.

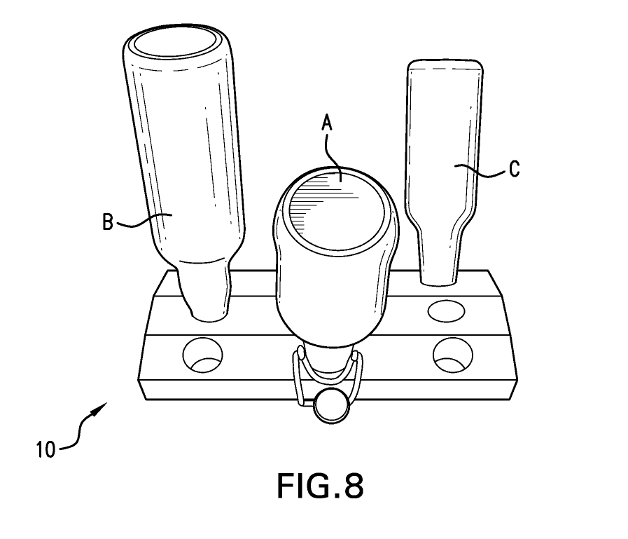

As shown in FIGS. 2-7, bottle drying holes 12, 20 preferably are provided with bottle drying hole notches 14, which allow for the swing tops on Grolsch bottle top bottles, as shown in FIG. 1 at A, and in FIG. 8. Notches are on opposite sides of each bottle drying hole, and are preferably ¼″ to ½″ inch in depth, and ¼″ to ½″ in length.

In some embodiments, the bottle drying holes 12, 20 have a taper from top to bottom.

The bottle dryer 10 may be made of wood, plastic, metal or any other suitable material.

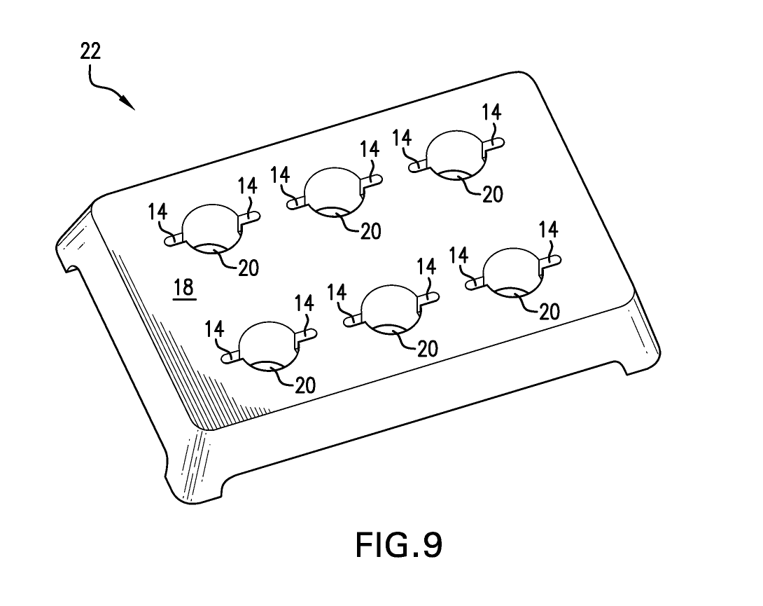

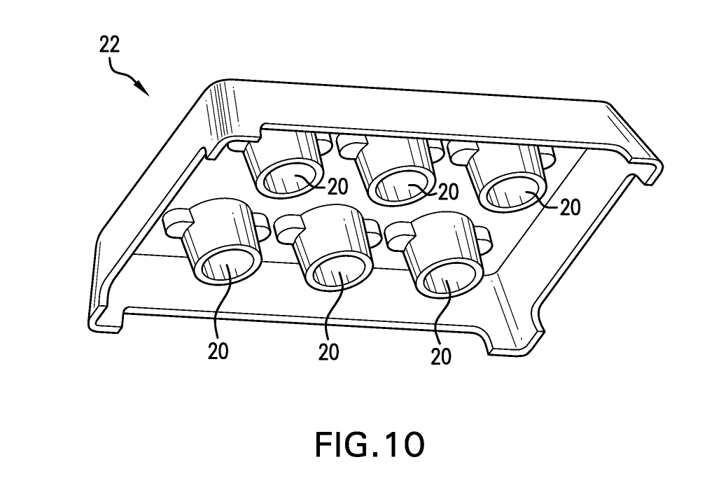

FIGS. 9 and 10 show a second embodiment of a bottle dryer 22. This embodiment is similar in most respects to the first embodiment, but does not have angled planes 16 and angled bottle drying holes 12. The bottle dryer 22 has a flat plane 18 and a plurality of straight bottle drying holes 20. The straight bottle drying holes 20 are spaced sufficiently apart so that beer bottles of 12 oz, 22 oz, and/or Grolsch type can be inserted top down in the straight bottle drying holes 20 without any of the bottles touching each other. The straight bottle drying holes 20 preferably are provided with bottle drying hole notches 14, which allow for the swing tops on Grolsch bottle top bottles.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

We claim:

1. A bottle dryer, comprising:
a flat plane with a plurality of straight bottle drying holes into which 12 oz, 22 oz, and/or Grolsch type beer bottles can be inserted top down without contacting each other.

2. The bottle of claim 1, further comprising:
a first angled plane to one side of said flat plane, the first angled plane with a first set of angled bottle drying holes into which 12 oz, 22 oz, and/or Grolsch type beer bottles can be inserted top down at a first angle from the flat plane.

3. The bottle of claim 2, further comprising:
a second angled plane to one side of said flat plane, the second angled plane with a second set of angled bottle drying holes into which 12 oz, 22 oz, and/or Grolsch type beer bottles can be inserted top down at a second angle from the flat plane.

4. The bottle of claim 3 wherein at least one of the angled bottle drying holes has bottle drying hole notches.

5. The bottle of claim 1 wherein at least one of the plurality of straight bottle drying holes has bottle drying hole notches.

6. The bottle of claim 1 wherein at least one of the plurality of straight bottle drying holes has a taper from top to bottom.
